(19) United States
(12) Patent Application Publication
(10) Pub. No.: US 2023/0328146 A1
(43) Pub. Date: Oct. 12, 2023

(54) Return-To-Site Tool Upholding Distance via Physical and Logical Indicators

(71) Applicant: Dell Products L.P., Round Rock, TX (US)

(72) Inventors: Yevgeni Gehtman, Modi'in (IL); Maxim Balin, Gan - Yavne (IL); Tomer Shachar, Beer-Sheva (IL)

(73) Assignee: Dell Products L.P., Round Rock, TX (US)

(21) Appl. No.: 17/718,482

(22) Filed: Apr. 12, 2022

(51) Int. Cl. H04L 67/52

(52) U.S. Cl. CPC H04L 67/52

(57) ABSTRACT

Methods, system, and non-transitory processor-readable storage medium for a location verification system are provided herein. An example method includes detecting an attempt to access a network from a computerized device located at a physical location. The location verification system determines access status based on a distance requirement between the computerized device and another computerized device.

### FIELD

The field relates generally to implementing safety measures, and more particularly to maintaining safety of the workforce within the office environment using information processing systems.

### BACKGROUND

In public health, social distancing, also called physical distancing, is a set of non-pharmaceutical interventions or measures intended to prevent the spread of a contagious disease by maintaining a physical distance between people, and reducing the number of times people come into close contact with each other.

### SUMMARY

Illustrative embodiments provide techniques for implementing a location verification system in a storage system to link an employee's physical location with the employee's logical identity. For example, illustrative embodiments detect an attempt to access a network from a computerized device located at a physical location and determine, by the location verification system, access status based on a distance requirement between the computerized device and another computerized device. Other types of processing devices can be used in other embodiments.

These and other illustrative embodiments include, without limitation, apparatus, systems, methods and processor-readable storage media.

### BRIEF DESCRIPTION OF THE DRAWINGS

FIG. 1 shows an information processing system including a location verification system in an illustrative embodiment.

FIG. 2 shows a flow diagram of a process for location verification in an illustrative embodiment.

FIGS. 3 and 4 show examples of processing platforms that may be utilized to implement at least a portion of a location verification system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a location verification system, which technique may be used to provide, among other things, linking an employee's physical location with the employee's logical identity to maintain a physical distance between people, and reducing the number of times people come into close contact with each other. The location verification system detects an attempt to access a network from a computerized device located at a physical location and determines access status based on a distance requirement between the computerized device and another computerized device.

With a heightened awareness of the transmission of airborne illnesses, the new reality requires facilities to know how many employees are in the same workspace at the same time, where each employee is sitting, whether those areas have been sanitized, whether the employees are maintaining social distancing requirements within their workspaces, and whether the employee is sitting in the correct office at the specific day and time for which approval was granted.

Conventional technologies for validating access on a LAN network do not validate access while also maintaining social distancing to prevent the spread of illnesses. Conventional technologies do not prevent users from breaking social distancing rules when connecting to a LAN network. Conventional technologies do not notify users when they have attempted to connect to the LAN network from a non-authorized office, and re-direct the user to a socially distanced authorized office. Conventional technologies do not automatically maintain social distancing without involving the need to have personnel actively supervising the social distancing among users. Conventional technologies do not detect and prevent exceeding capacity limits that would breach social distancing rules. Conventional technologies do not automatically assign users to available working spaces while efficiently incorporating social distancing requirements. Conventional technologies do not monitor and control, in real time, the access to the LAN network while maintaining social distancing. Conventional technologies do not identify every computerized device that tries to access the LAN network with a monovalent identifier that is based on hardware and software indicators.

By contrast, in at least some implementations in accordance with the current technique as described herein, a location verification system detects an attempt to access a network from a computerized device located at a physical location and determines access status based on a distance requirement between the computerized device and another computerized device.

Thus, a goal of the current technique is to provide a method and a system for providing a location verification system that can link an employee's physical location with the employee's logical identity to maintain a physical distance between people. Another goal is to automatically assign users to available working spaces while efficiently incorporating social distancing requirements. Yet another goal is to validate access while also maintaining social distancing to prevent the spread of illnesses. Yet another goal is to prevent users from breaking social distancing rules when connecting to a LAN network, notify users when they have attempted to connect to the LAN network from a non-authorized office, and re-direct the user to a socially distanced authorized office.

In at least some implementations in accordance with the current technique described herein, the use of a location verification system can provide one or more of the following advantages: maintaining a physical distance between people by linking an employee's physical location with the employee's logical identity, validating access while also maintaining social distancing to prevent the spread of illnesses, detecting and preventing exceeding capacity limits that would breach social distancing rules, monitoring and controlling, in real time, the access to the LAN network while maintaining social distancing, and identifying every computerized device that tries to access the LAN network with a monovalent identifier that is based on hardware and software indicators.

In contrast to conventional technologies, in at least some implementations in accordance with the current technique as described herein, a physical distance is maintained between people, and the number of times people come into close contact with each other is reduced by linking an employee's physical location with the employee's logical identity. The location verification system detects an attempt to access a network from a computerized device located at a physical location and determines access status based on a distance requirement between the computerized device and another computerized device.

In an example embodiment of the current technique, the distance requirement is a social distancing requirement to prevent spreading illness.

In an example embodiment of the current technique, the network switch receives a unique identifier associated with the computerized device and a physical port associated with the physical location, and transmits the unique identifier and the physical port associated with the physical location, to the location verification system.

In an example embodiment of the current technique, the location verification system accesses a user profile repository comprising at least one user identifier, and matches the unique identifier associated with the computerized device to a user identifier in the user profile repository.

In an example embodiment of the current technique, the location verification system transmits a user identifier associated with the computerized device to a location scheduling system. In response, the location verification system receives the physical location assigned to a user associated with the user identifier.

In an example embodiment of the current technique, the location verification system determines the computerized device is connected to a physical port associated with the physical location. The location verification system verifies the computerized device has authorization from a location scheduling system to connect to the physical port associated with the physical location, where the physical location is a single user office and the physical port is only accessible at the physical location. The location verification system then grants the computerized device access to the network.

In an example embodiment of the current technique, the location verification system determines the computerized device is connected to a physical port associated with the physical location, and attempts to verify that the computerized device has authorization, from a location scheduling system, to connect to the physical port associated with the physical location. The location verification system denies the computerized device access to the network when the attempt to verify fails.

In an example embodiment of the current technique, the location verification system notifies a user that the location verification system has not authorized the user to connect to the physical port.

In an example embodiment of the current technique, the location verification system notifies a user of another physical location comprising an authorized physical port in which to connect the computerized device.

In an example embodiment of the current technique, a unique identifier associated with the computerized device is generated based on unique indicators comprising at least one of Basic Input/Output System (BIOS) serial number, RSA ID, Virtual Private Network (VPN) identification, Media Access Control (MAC) address associated with hardware, Central Processing Unit (CPU) serial number, Graphics Processing Unit (GPU) serial number, Random-Access Memory (RAM) part number, monitor serial number, Domain Name System (DNS) server, Dynamic Host Configuration Protocol (DHCP) server, and/or Internet Protocol (IP) address.

In an example embodiment of the current technique, the location verification system verifies a scheduling time frame associated with the access status and verifies a booking status associated with the physical location when the scheduling time frame expires.

In an example embodiment of the current technique, the location verification system terminates network access to the computerized device at the physical location when the scheduling time frame expires if the booking status indicates a user associated with the computerized device is not scheduled for access at the physical location when the time frame expires.

In an example embodiment if the booking status indicates a new user is scheduled for network access at the physical location when the time frame expires, the location verification system may continue to deny the new user network access for a short time block to allow a cleaning crew to disinfect the physical location before the new user enters the physical location to connect to the network.

In an example embodiment of the current technique, the location verification system notifies the user prior to the termination that the network access termination is impending.

In an example embodiment of the current technique, the location verification system extends network access to the computerized device at the physical location if the booking status indicates no user is scheduled for access at the physical location when the time frame expires.

In an example embodiment of the current technique, the location verification system notifies a user that the location verification system requires an approval from the user to extend the network access to the computerized device.

In an example embodiment of the current technique, the location verification system detects that a user has swiped an identification card in a card reader and transmits a user identifier associated with the identification card to a location scheduling system. The location verification system receives, from the location scheduling system, a location capacity status and denies the user access to a facility location, where the facility location comprises the physical location.

In an example embodiment of the current technique, the location verification system notifies the user of the access denial due to the location capacity status.

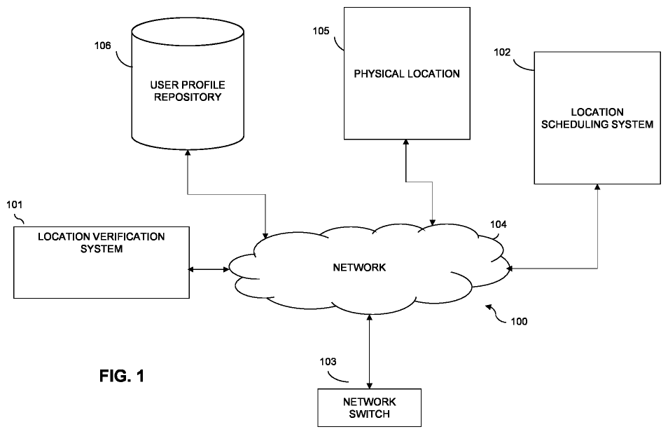

FIG. 1 shows a computer network (also referred to herein as an information processing system) 100 configured in accordance with an illustrative embodiment. The computer network 100 comprises a location scheduling system 102, switch 103, physical location 105, and user profile repository 106. The location scheduling system 102, switch 103, physical location 105, and user profile repository 106 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a location verification system 101 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the location verification system 101, location scheduling system 102, switch 103, physical location 105, and user profile repository 106 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The location verification system 101, location scheduling system 102, switch 103, physical location 105, and user profile repository 106 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the location verification system 101 and location scheduling system 102 are one or more input-output devices, which illustratively comprise keyboards, displays or other types of input-output devices in any combination. Such input-output devices can be used, for example, to support one or more user interfaces to the location verification system 101, as well as to support communication between the location verification system 101 and other related systems and devices not explicitly shown. One or more input-output devices may also be associated with any of the location scheduling system 102, switch 103, physical location 105, and user profile repository 106.

Additionally, the location verification system 101 in the FIG. 1 embodiment is assumed to be implemented using at least one processing device. Each such processing device generally comprises at least one processor and an associated memory, and implements one or more functional modules for controlling certain features of the location verification system 101.

More particularly, the location verification system 101 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the location verification system 101 to communicate over the network 104 with the location scheduling system 102, switch 103, physical location 105, and user profile repository 106 and illustratively comprises one or more conventional transceivers.

A location verification system 101 may be implemented at least in part in the form of software that is stored in memory and executed by a processor, and may reside in any processing device. The location verification system 101 may be a standalone plugin that may be included within a processing device.

It is to be understood that the particular set of elements shown in FIG. 1 for location verification system 101 involving the location scheduling system 102, switch 103, physical location 105, and user profile repository 106 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the location verification system 101 can be on and/or part of the same processing platform.

In an example embodiment, a user registers with the location scheduling system 102 using a user identifier to schedule time in a physical location 105 (i.e., an office in a building). When the user arrives at the physical location 105, the user connects their computerized device to a physical port associated with the physical location 105. In response, the switch 103 receives the unique identifier associated with the computerized device and the physical port associated with the physical location 105. The switch 103 transmits the unique identifier and the physical port associated with the physical location 105 to the location verification system 101. The location verification system 101 accesses the user profile repository 106 to match the unique identifier associated with the computerized device to a user identifier in the user profile repository 106. The location verification system 101 transmits the user identifier associated with the computerized device to the location scheduling system 102, and in response, receives from the scheduling system 102 the physical location 105 assigned to the user associated with the user identifier, along with the date and time period for which the user is authorized to access the network. The location verification system 101 determines that the computerized device is connected to a physical port associated with the physical location 105 and verifies that the computerized device has authorization from the location scheduling system 102 to connect to the physical port associated with the physical location 105 before granting access to the network. In other words, a user enters an office (i.e., the physical location 105) and connects their computerized device to a physical port, for example, a docking station connected to the network. If the user has authorization from the location scheduling system 102 to connect their computerized device to the physical port in that office, the location verification system 101 grants the computerized device access to the network.

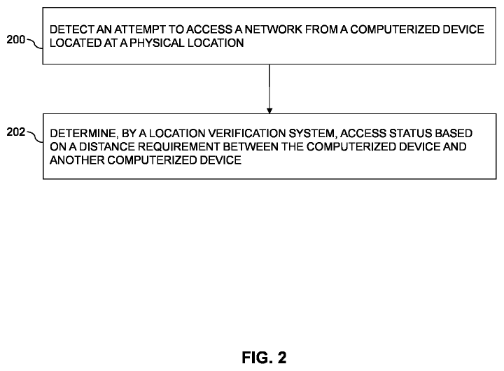

An exemplary process of location scheduling system 102, switch 103, physical location 105, and user profile repository 106 in computer network 100 will be described in more detail with reference to, for example, the flow diagram of FIG. 2.

Referring now to FIG. 2, this figure is a flow diagram of a process for execution of the location verification system 101 in an illustrative embodiment. It is to be understood that this particular process is only an example, and additional or alternative processes can be carried out in other embodiments.

At 200, the location verification system 101 detects an attempt to access a network from a computerized device located at a physical location 105. For example, a user may have attempted to connect to a company network. In an example embodiment, in response to the attempt to connect, the switch 103 receives a unique identifier associated with the computerized device and a physical port associated with the physical location 105.

In an example embodiment, each computerized device on the network is identified by a unique identifier. The unique identifier may be generated by, but is not limited to, the hardware and user attributes associated with the computerize device. In an example embodiment, the unique identifier is stored on the computerized device. The unique identifier may be generated via unique indicators based on both software and hardware components. In an example embodiment, the unique indicators may be, but are not limited to, a Basic Input/Output System (BIOS) serial number, RSA ID, Virtual Private Network (VPN) identification, Media Access Control (MAC) address associated with hardware, Central Processing Unit (CPU) serial number, Graphics Processing Unit (GPU) serial number, Random-Access Memory (RAM) part number, monitor serial number, Domain Name System (DNS) server, Dynamic Host Configuration Protocol (DHCP) server, and/or Internet Protocol (IP) address (if the IP address is static).

In an example embodiment, in response to the switch 103 receiving the unique identifier associated with the computerized device, the switch 103 transmits the unique identifier and the physical port associated with the physical location 105 to the location verification system 101. The location verification system 101 accesses the user profile repository 106 that stores a plurality of user identifiers. The location verification system 101 then matches the unique identifier associated with the computerized device to the user identifier.

At 202, the location verification system 101 determines access status based on a distance requirement between the computerized device and another computerized device. In an example embodiment, the distance requirement is a social distancing requirement to prevent spreading illness. For example, there may be national, local and/or company specific social distancing requirements to prevent the spread of, for example, airborne illnesses. In an example embodiment, the location verification system 101 may coordinate with the location scheduling system 102 to ensure that when users register with the location scheduling system 102 to reserve office space, the minimum distance requirements are maintained between offices.

In an example embodiment, in response to the location verification system 101 matching the unique identifier associated with the computerized device to the user identifier, the location verification system 101 transmits the user identifier associated with the computerized device to the location scheduling system 102, and receives, in response, the physical location 105 (for example, an office number, etc., identifying the physical location 105) assigned to the user associated with the user identifier.

In an example embodiment, the location verification system 101 determines that the computerized device is connected to a physical port associated with the physical location 105. The location verification system 101 then verifies that the computerized device has authorization from the location scheduling system 102 to connect to the physical port associated with physical location 105. In an example embodiment, the physical location 105 is a single user office and the physical port is only accessible at the physical location 105. Once the location verification system 101 confirms that the computerized device has authorization from the location scheduling system 102 to connect to the physical port, the location verification system 101 grants the computerized device access to the network. Thus, the location verification system 101 links the physical location 105 of the user with the logical identity on a Local Area Network (LAN) to correspond with the social distancing requirements to protect the users (i.e., the employees) of a workplace.

In an example embodiment, once the location verification system 101 determines that the computerized device is connected to a physical port associated with the physical location 105, the location verification system 101 attempts to verify if the computerized device has authorization, from the location scheduling system 102 to connect to the physical port associated with the physical location 105, and the attempt to verify fails. In this example scenario, the location verification system 101 denies the computerized device access to the network. In an example embodiment, the location verification system 101 notifies the user that the location verification system 101 has not authorized the user to connect to the physical port. The user may be notified, for example, by the location verification system 101 via a Send and Receive Text Message (SMS), however, other means may also be used to notify the user of the access denial. In an example embodiment, the access denial may be due to the fact that the user did not reserve the physical location 105. In this case, the location scheduling system 102 notifies the location verification system 101 that the location scheduling system 102 does not have the user scheduled to connect to that physical port at that date and time. In another example embodiment, the access denial may be due to the fact that the user has properly reserved an office (i.e., the physical location 105), but has mistakenly tried to connect their computerized device in the wrong office. In this example embodiment, the location verification system 101 receives the user's scheduling information from the location scheduling system 102, and determines the user is simply trying to connect their computerized device in the wrong office (i.e., physical location 105). In this example scenario, the location verification system 101 notifies the user (for example, via SMS text message) of another physical location 105 comprising an authorized physical port in which to connect the computerized device. Thus, the location verification system 101 actively verifies and validates that each user is stationed at the correct physical location 105 as assigned.

In an example embodiment, the location verification system 101 verifies with the location scheduling system 102 the scheduling time frame associated with the access status, for example, how long the user is authorized to receive network access at the physical port. The location verification system 101 also verifies the booking status associated with the physical location 105 when the scheduling time frame expires. In other words, the location verification system 101 verifies with the location scheduling system 102 when and how long the user is scheduled to have access to the network at that physical port, and when that time period expires, the location verification system 101 verifies who else, if anybody is scheduled to be authorized to access the network through the physical port. In one example embodiment, the location verification system 101 terminates the network access to the computerized device at the physical location 105 when the scheduling time frame expires if the booking status indicates a user associated with the computerized device is not scheduled for access at the physical location 105 when the time frame expires. Thus, when the user schedules network access at the physical location 105 for a particular time period, the location verification system 101 terminates the network access when that time period expires if another user has scheduled that physical location 105 via the location scheduling system 102, for the subsequent time period after the time period expires. In this example, embodiment, the location verification system 101 notifies the user prior to the termination that the network access termination is impending, for example, providing warnings 30 minutes and then 15 minutes before the network access is scheduled to expire. In an example embodiment if the booking status indicates a new user is scheduled for network access at the physical location 105 when the time frame expires, the location verification system 101 may continue to deny the new user network access for a short time block to allow a cleaning crew to disinfect the physical location 105 before the new user enters the physical location to connect to the network.

In another example embodiment, the location verification system 101 extends the network access to the computerized device at the physical location 105 if the booking status indicates no user is scheduled for access at the physical location 105 when the time frame expires. In other words, the location verification system 101 extends the network access to the user if the subsequent time period (i.e., after the initial time period expires) is not booked for another user. In this example embodiment, the location verification system 101 notifies a user for example, via SMS text message, that the location verification system 101 requires an approval from the user to extend the network access to the computerized device. The user would then have to accept the extension of the network access before the location verification system 101 extends the network access beyond the initial time period that the user scheduled via the location scheduling system 102.

In an example embodiment, the user may self-identify their vaccination status, quarantine status, and/or personal preference for wanting more space from colleagues than the social distance guidelines dictate. In this example scenario, the location verification system 101 will obtain the user status from the location scheduling system 102 and will deny or grant network access based on the user status and the social distancing requirements. In an example embodiment, the location verification system 101 may also maintain a table that associates a respective social distance for each user who is registered with the location scheduling system 102 so as to grant or deny network access to other users based on the social distancing needs of each user. In another example embodiment, the location verification system 101 may socially distance groups of users based on, for example, vaccination status, illness status, quarantine status, exposure status (i.e, users who have mingled with customers may be kept separate from users who have not mingled with customers), and/or privacy status (i.e., keeping groups of users who work on projects requiring confidentiality and privacy from other groups of users).

In an example embodiment, the location verification system 101 detects that the user has swiped an identification card in a card reader, for example, when the user enters a facility location (i.e., a building) in which the physical location 105 (i.e., an office) resides, to be granted access to the building. The location verification system 101 then transmits the user identifier associated with the identification card the location scheduling system 102. In response, the location verification system 101 receives a location capacity status from the location scheduling system 102. If the building is over capacity, for example, due to social distancing requirements, the location verification system 101 denies the user access to the facility location. In this example scenario, the location verification system 101 notifies the user, for example, via SMS text, of the access denial due to the location capacity status (for example, a limit on the number of people who may be inside the facility location at the same time). The user may receive a text message stating that the building is over capacity. The user, for example, may then wait outside the building to see if anyone exits the building, and then may try again to enter the building.

Accordingly, the particular processing operations and other functionality described in conjunction with the flow diagram of FIG. 2 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly improve social distancing compliance relative to conventional approaches. For example, embodiments disclosed herein maintain a physical distance between people by linking an employee's physical location with the employee's logical identity. Embodiments disclosed herein validate access while also maintaining social distancing to prevent the spread of illnesses. Embodiments disclosed herein detect and prevent exceeding capacity limits that would breach social distancing rules. Embodiments disclosed herein monitor and control, in real time, the access to the LAN network while maintaining social distancing. Embodiments disclosed herein identify every computerized device that tries to access the LAN network with a monovalent identifier that is based on hardware and software indicators.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

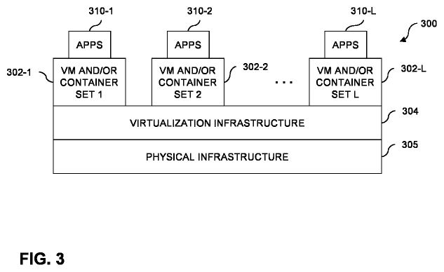

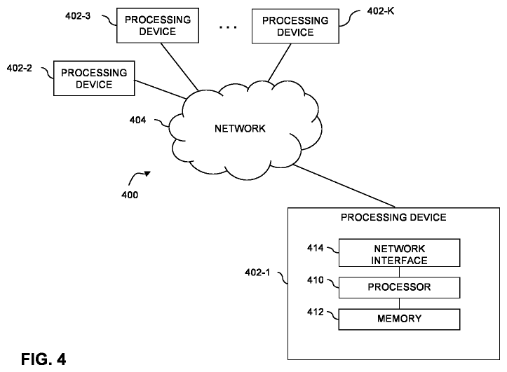

Illustrative embodiments of processing platforms will now be described in greater detail with reference to FIGS. 3 and 4. Although described in the context of the information processing system 100, these platforms may also be used to implement at least portions of other information processing systems in other embodiments.

FIG. 3 shows an example processing platform comprising cloud infrastructure 300. The cloud infrastructure 300 comprises a combination of physical and virtual processing resources that are utilized to implement at least a portion of the information processing system 100. The cloud infrastructure 300 comprises multiple virtual machines (VMs) and/or container sets 302-1, 302-2, . . . 302-L implemented using virtualization infrastructure 304. The virtualization infrastructure 304 runs on physical infrastructure 305, and illustratively comprises one or more hypervisors and/or operating system level virtualization infrastructure. The operating system level virtualization infrastructure illustratively comprises kernel control groups of a Linux operating system or other type of operating system.

The cloud infrastructure 300 further comprises sets of applications 310-1, 310-2, . . . 310-L running on respective ones of the VMs/container sets 302-1, 302-2, . . . 302-L under the control of the virtualization infrastructure 304. The VMs/container sets 302 comprise respective VMs, respective sets of one or more containers, or respective sets of one or more containers running in VMs. In some implementations of the FIG. 3 embodiment, the VMs/container sets 302 comprise respective VMs implemented using virtualization infrastructure 304 that comprises at least one hypervisor.

A hypervisor platform may be used to implement a hypervisor within the virtualization infrastructure 304, where the hypervisor platform has an associated virtual infrastructure management system. The underlying physical machines comprise one or more distributed processing platforms that include one or more storage systems.

In other implementations of the FIG. 3 embodiment, the VMs/container sets 302 comprise respective containers implemented using virtualization infrastructure 304 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 300 shown in FIG. 3 may represent at least a portion of one processing platform. Another example of such a processing platform is processing platform 400 shown in FIG. 4.

The processing platform 400 in this embodiment comprises a portion of the information processing system 100 and includes a plurality of processing devices, denoted 402-1, 402-2, 402-3, . . . 402-K, which communicate with one another over a network 404.

The network 404 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 402-1 in the processing platform 400 comprises a processor 410 coupled to a memory 412.

The processor 410 comprises a microprocessor, a microcontroller, an application-specific integrated circuit (ASIC), a field-programmable gate array (FPGA) or other type of processing circuitry, as well as portions or combinations of such circuitry elements.

The memory 412 comprises random access memory (RAM), read-only memory (ROM) or other types of memory, in any combination. The memory 412 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 402-1 is network interface circuitry 414, which is used to interface the processing device with the network 404 and other system components, and may comprise conventional transceivers.

The other processing devices 402 of the processing platform 400 are assumed to be configured in a manner similar to that shown for processing device 402-1 in the figure.

Again, the particular processing platform 400 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
detecting an attempt to access a network from a computerized device located at a physical location; and
determining, by a location verification system, access status based on a distance requirement between the computerized device and a second computerized device, wherein the access status indicates how long the user associated with the computerized device is authorized to receive network access at the physical port and at the physical location, wherein the location verification system links the physical location of the user with a logical identity on a Local Area Network (LAN) to correspond with the distance requirement to protect the user and a second user associated with the second computerized device, wherein the method is implemented by at least one processing device comprising a processor coupled to a memory.

2. The method of claim 1 wherein the distance requirement is a social distancing requirement, based on social distancing needs of each user.

3. The method of claim 1 wherein detecting the attempt to access the network comprises:
receiving, by a network switch, a unique identifier associated with the computerized device and a physical port associated with the physical location; and
transmitting, by the network switch, the unique identifier and the physical port associated with the physical location, to the location verification system.

4. The method of claim 3 further comprising:
accessing, by the location verification system, a user profile repository comprising at least one user identifier; and
matching the unique identifier associated with the computerized device to a user identifier in the user profile repository.

5. The method of claim 1 wherein determining, by the location verification system, the access status comprises:
transmitting, by a location verification system, a user identifier associated with the computerized device to a location scheduling system; and
in response, receiving by the location verification system, the physical location assigned to a user associated with the user identifier.

6. The method of claim 1 wherein determining, by the location verification system, the access status comprises:
determining the computerized device is connected to a physical port associated with the physical location;
verifying the computerized device has authorization, from a location scheduling system, to connect to the physical port associated with the physical location, wherein the physical location is a single user office and the physical port is only accessible at the physical location; and
granting the computerized device access to the network.

7. The method of claim 1 wherein determining, by the location verification system, the access status comprises:
determining the computerized device is connected to a physical port associated with the physical location;
attempting to verify the computerized device has authorization, from a location scheduling system, to connect to the physical port associated with the physical location; and
denying the computerized device access to the network when the attempt to verify fails.

8. The method of claim 7 further comprising:
notifying a user that the location verification system has not authorized the user to connect to the physical port.

9. The method of claim 7 further comprising:
notifying a user of another physical location comprising an authorized physical port in which to connect the computerized device.

10. The method of claim 1 wherein a unique identifier associated with the computerized device is generated based on unique indicators comprising at least one of Basic Input/Output System (BIOS) serial number, RSA ID, Virtual Private Network (VPN) identification, Media Access Control (MAC) address associated with hardware, Central Processing Unit (CPU) serial number, Graphics Processing Unit (GPU) serial number, Random-Access Memory (RAM) part number, monitor serial number, Domain Name System (DNS) server, Dynamic Host Configuration Protocol (DHCP) server, and/or Internet Protocol (IP) address.

11. The method of claim 1 wherein determining, by the location verification system, the access status comprises:
verifying, by the location verification system, a scheduling time frame associated with the access status; and
verifying a booking status associated with the physical location when the scheduling time frame expires.

12. The method of claim 11 further comprising:
terminating network access to the computerized device at the physical location when the scheduling time frame expires if the booking status indicates a user associated with the computerized device is not scheduled for access at the physical location when the time frame expires.

13. The method of claim 12 wherein terminating network access to the computerized device at the physical location comprises:
notifying the user prior to the termination that the network access termination is impending.

14. The method of claim 11 further comprising:
extending network access to the computerized device at the physical location if the booking status indicates no user is scheduled for access at the physical location when the time frame expires.

15. The method of claim 14 wherein extending the network access to the computerized device comprises:
notifying a user that the location verification system requires an approval from the user to extend the network access to the computerized device.

16. The method of claim 1 wherein detecting the attempt to access the network comprises:
detecting a user has swiped an identification card in a card reader; and
wherein determining, by the location verification system, access status comprises:
transmitting, by location verification system, a user identifier associated with the identification card to a location scheduling system;
receiving, by the location verification system, from the location scheduling system a location capacity status; and
denying the user access to a facility location, wherein the facility location comprises the physical location.

17. The method of claim 16 further comprising:
notifying the user of the access denial due to the location capacity status.

18. A system comprising:
at least one processing device comprising a processor coupled to a memory;
the at least one processing device being configured:
to detect an attempt to access a network from a computerized device located at a physical location; and
to determine, by a location verification system, access status based on a distance requirement between the computerized device and a second computerized device wherein the access status indicates how long the user associated with the computerized device is authorized to receive network access at the physical port and at the physical location, wherein the location verification system links the physical location of the user with a logical identity on a Local Area Network (LAN) to correspond with the distance requirement to protect the user and a second user associated with the second computerized device.

19. The system of claim 18 wherein the distance requirement is a social distancing requirement, based on social distancing needs of each user.

20. A computer program product comprising a non-transitory processor-readable storage medium having stored therein program code of one or more software programs, wherein the program code when executed by at least one processing device causes said at least one processing device:
to detect an attempt to access a network from a computerized device located at a physical location; and
to determine, by a location verification system, access status based on a distance requirement between the computerized device and a second computerized device wherein the access status indicates how long the user associated with the computerized device is authorized to receive network access at the physical port and at the physical location, wherein the location verification system links the physical location of the user with a logical identity on a Local Area Network (LAN) to correspond with the distance requirement to protect the user and a second user associated with the second computerized device.
